(19) United States
(12) Patent Application Publication
(10) Pub. No.: US 2002/0020065 A1
(43) Pub. Date: Feb. 21, 2002

(54) Shaving system

(75) Inventor: Mingchih M. Tseng, Hingham, MA (US)

Correspondence Address: FISH & NEAVE, 1251 AVENUE OF THE AMERICAS, 50TH FLOOR, NEW YORK, NY, 10020-1105, US

(73) Assignee: The Gillette Company

(21) Appl. No.: 09/950,517

(22) Filed: Sep. 10, 2001

Related U.S. Application Data
(63) Continuation of application No. 08/926,819, filed on Sep. 10, 1997.
Application No. 08/926,819 is a continuation of application No. 08/461,318, filed on Jun. 20, 1995.
Application No. 08/461,318 is a continuation-in-part of application No. 08/269,495, filed on Jul. 1, 1994, now abandoned.

(51) Int. Cl. B26B 21/00

(52) U.S. Cl. 30/41; 30/50

(57) ABSTRACT

In accordance with one aspect of the invention, there is provided a shaving unit that comprises at least one blade and a skin engaging member that has a surface for engaging the user's skin adjacent the blade edge. The shaving unit may be of a disposable cartridge type adapted for coupling to and uncoupling from a razor handle or may be integral with a handle so that the complete razor is discarded as a unit when the blade or blades become dulled. The blade edge (or edges) cooperate with skin engaging surfaces to defines having geometry. The skin engaging member is comprised of an elongated sheath made of a mixture of water insoluble matrix material and an effective amount of shaving aid material and a rigid core material extending axially through out said sheath. The axial position of the core need not be through the central axis.

This application is a continuation-in-part of U.S. Ser. No. 08/269,495, filed Jul. 1, 1994.

### BACKGROUND OF THE INVENTION

1. Field of the Invention

This invention relates to an improved skin engaging member for use in razor blade cartridge assemblies and shaving systems of the wet shave type. The present invention resides broadly in providing the skin engaging cap and/or guard surfaces with configurations which reduce frictional drag of the razor across the skin. This invention also relates to a novel method of manufacturing the skin engaging member of the present invention.

2. Description of the Prior Art

In shaving systems of the wet shave type, factors such as the frictional drag of the razor across the skin, the force needed to sever hairs, and irritation of pre-existing skin damage can create a degree of shaving discomfort. Discomfort, and other problems accompanying wet shaving systems, can be alleviated by the application of shaving aids to the skin. Shaving aids may be applied prior to, during, or after shaving. A number of problems accompany the use of pre- and post-applied shaving aids. Pre-applied-shaving aids can evaporate or can be carried away from the site of application by repeated strokes of the razor. Post-applied-shaving aids are not present on the skin during shaving and thus their application may be too late to prevent an unwanted affect. Both pre-applied and post-applied shaving aids add additional steps to the shaving process.

Proposals have been made to incorporate a shaving aid e.g., lubricant, whisker softener, razor cleanser, medicinal agent, cosmetic agent or combination thereof, into a razor, e.g., by depositing a shaving aid in a recess on the razor, by incorporating a shaving aid directly into one or more molded polymeric components of the razor, by adhesively securing a shaving aid composite to the razor, and by use of a mechanical connection between a shaving aid composite and the razor. A water-soluble shaving aid, e.g. polyethylene oxide, has been mixed with non-water-soluble material, e.g., a polystyrene polymer, to form an insoluble polymer/soluble shaving aid composite. The composite has been mounted on razor and shaving cartridge structures, adjacent the shaving edge or edges, of single or multiple blade shaving system. Upon exposure to water, the water-soluble shaving aid leaches from the composite onto the skin.

Extruded composites with relatively large amounts of shaving agent material (up to 80% by weight) and relatively low amounts of water insoluble matrix material (as little as 20% by weight) are relatively weak and have a tendency towards mechanical failure, both in assembly and in use. Increase in mechanical strength can be obtained with increased amounts of the matrix material. However, such increase reduces the releasability of the shaving material.

### SUMMARY OF THE INVENTION

In accordance with one aspect of the invention, there is provided a shaving unit that comprises at least one blade and a skin engaging member that has a surface for engaging the user's skin adjacent the blade edge. The shaving unit may be of a disposable cartridge type adapted for coupling to and uncoupling from a razor handle or may be integral with a handle so that the complete razor is discarded as a unit when the blade or blades become dulled. The blade edge (or edges) cooperate with skin engaging surfaces to defines having geometry. The skin engaging member is comprised of an elongated sheath made of a mixture of water insoluble matrix material and an effective amount of shaving aid material and a rigid core material extending axially through out said sheath. The axial position of the core need not be through the central axis.

An object of the present invention is to provide a skin engaging member with improved mechanical strength.

Another object of the present invention is to provide a skin engaging member with improved shaving aid material release characteristics.

Yet another object of the present invention is to provide a wear indicating skin engaging member.

These and other objects should be evident from the following:

### BRIEF DESCRIPTION OF THE DRAWINGS

FIG. 1 is a perspective view of a razor unit in accordance with the invention;

FIG. 2 is a sectional view taken along the line 2-2 of FIG. 1;

FIG. 3 is a perspective view of another razor unit in accordance with the invention;

FIG. 4 is an enlarged perspective view of a skin engaging member of the present invention;

FIG. 5 is sectional view taken along the line 3-3 of FIG. 4;

FIGS. 6-7 are sectional views in accordance with FIG. 5 wherein alternate core geometry's are depicted;

FIG. 8 is yet another cross-sectional depiction;

FIG. 9 is a schematic cross-section diagram of an extrusion die suitable for manufacturing the skin engaging member of FIG. 4.

### DESCRIPTION OF PARTICULAR EMBODIMENTS

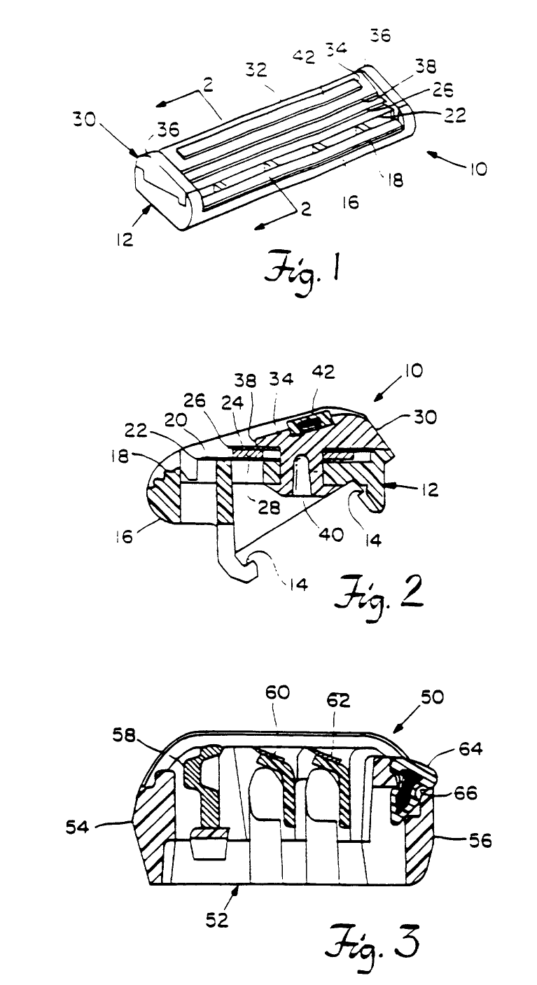

The shaving unit 10 shown in FIGS. 1 and 2 includes base or platform member 12 molded of high impact polystyrene that includes integral coupling groove structure 14 for attachment to a razor handle and guard structure 16 that defines a transversely extending forward skin engaging surface 18. On the upper surface of platform 12 are disposed steel leading blade 20 having a sharpened edge 22, steel following blade 24 having sharpened edge 26, and aluminum spacer member 28 that maintains blades 20 and 24 in spaced relation. Cap member 30 is molded of high impact polystyrene and has body portion 32 that defines skin engaging surface 34 that extends transversely between forwardly projecting end walls 36 and has a front edge 38 that is disposed rearwardly of blade edge 26. Integral rivet portions 40 extend downwardly from transversely extending body portion 32 and pass through holes in blades 20 and 24, spacer 28, and platform 12 to secure cap 30, blades 20, 24 and spacer 28 on platform 12. Adhesively affixed to skin engaging surface 34 is skin engaging member 42.

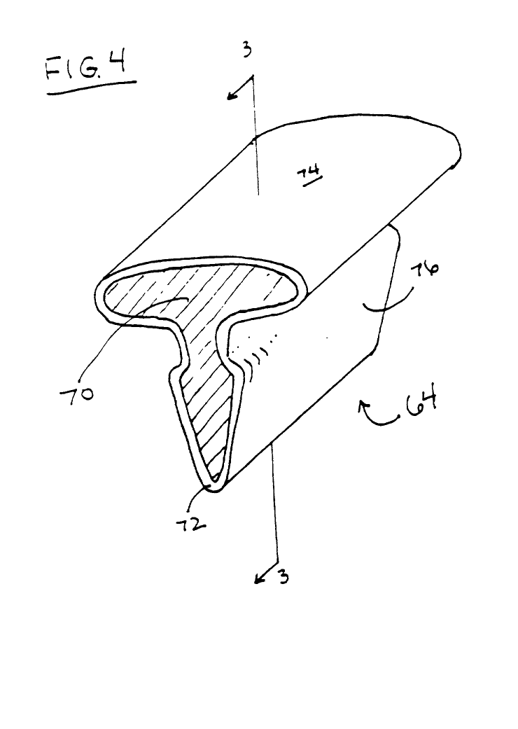

The shaving unit 50 shown in FIG. 3 is of the type shown in Jacobson U.S. Pat. No. 4,586,255 and includes body 52 with front portion 54 and rear portion 56. Resiliently secured in body 52 are guard member 58, leading blade unit 60 and trailing blade unit 62. A shaving aid composite in the form of elongated insert member 64 is frictionally locked in opening 66 of rear portion 56.

FIGS. 4-9 generally depict variations on the present invention. As used in herein, the term “core” refers to an internal portion of a skin engaging member as examined at the cross-section. The core typically runs throughout the skin engaging member along an axis. The axis need not be the central axis. The FIG's. designate the core as 70. Embodiments of the present invention have at least one core element. As used herein, the term “sheath” refers to an outer coating layer(s) over the core material 13. The FIG's. designate sheaths as 72.

Referring now to the drawings, and in particular to FIG. 4, there is shown an elongated skin engaging member 64. The member 64 has an skin engaging surface 74 and an elongated insert element 76. The insert member 76 is designed to frictionally lock in an opening as shown in FIG. 3. The skin engaging member further comprises a rigid core material 70 which is surrounded by a sheath material made of a mixture of water insoluble matrix material and an effective amount of shaving aid material.

The sheath material includes from about 0% to about 30% by weight preferably from about 5% to about 15% of the water insoluble matrix material and from about 70% to about 100% by weight of the shaving aid preferably from about 85% to about 95% material. Suitable water insoluble matrix materials include for example, nylon, ethylene-vinyl acetate copolymer, polyethylene, polypropylene, polystyrene, polyacetyl and combinations. Suitable shaving aid materials include, for example, polyethylene oxide, polyvinyl pyrrolidone, polyacrylamide, hydroxypropyl cellulose, polyvinyl imidazonline, polyethylene glycol, polyvinyl alcohol, methylcellulose, starch, water soluble vinyl polymers (Carbopol® brand sold by B.F. Goodrich), polyhydroxyethylmethacrylate, silicone copolymers, sucrose stearate, vitamin E, panthenol, aloe, essential oils such as menthol and combinations.

The sheath may include additional components such as: plastisizers, such as polyethylene glycol; beard softeners, such as Kraton G 13 A; additional lubricants, such as silicone oil, Teflon® polytetrafluoroethylene powders (manufactured by DuPont), and waxes; shaving aids, such as menthol, eugenol, eucalyptol, safrol and methyl salicylate; fillers, such as calcium carbonate, mica and fibers; tackifiers such as Hercules Regalrez 1094 and 1126; fragrances;antipruritic/counterirritant materials such as Frescolat; antimicrobial/keratolytic materials such as Resorcinol; anti-inflammatory agents such as Candilla wax and glycyrrhetinic acid; astringents such as zinc sulfate; surfactants such as pluronic and iconol materials; comptibilizers such as styrene-b-EO copolymers; and, blowing agents such as Uniroyal Celogen Aznp 130. These additives may leach from the surface to provide improved shaving. These components could be dispersed throughout the sheath or alternatively, a second, outer sheath containing the additional element could be extruded or merely coated over the primary sheath.

The present skin engaging member is produced by a coextrusion process whereby a rigid core material displaces a portion of the sheath material. The nature and relative portions of the sheath and core polymeric materials being such that the skin engaging member has adequate mechanical strength, both as initially produced and after a significant amount of water soluble material has been leached out, the quantity of the water-soluble material being sufficient to provide effective shaving assistance, such as lubrication, for the entire expected life of the blade or blades. The function of the core material is not only to provide additional rigidity but to displace trapped shaving aid material. In conventional skin engaging members, such as those described in U.S. Pat. Nos. 5,063,667; 5,095,619; and 5,113,585, a significant amount of shaving aid material is trapped within the insoluble matrix. By displacing it closer to the skin engaging surface 74, diffusional paths are reduced and more efficient delivery is achieved. Furthermore, the core material provides additional mechanical strength for the attaching mechanism, if used.

The core material must have sufficient mechanical strength and rigidity to provide adequate mechanical strength to the entire skin engaging member, both as initially produced and after a significant amount of water insoluble material has been leached out of the sheath. Preferably, the core material can be made from a non-water soluble plastic resin or a blend consisting of at least about 50% of non-water soluble plastic resin to prevent the core from disintegrating. Water-soluble resins for use in such blends include polyethylene oxide, polyvinyl pyrrolidone; polyacrylamide, hydroxypropyl cellulose, polyvinyl imidazoline, polyethylene glycol, polyvinyl alcohol, methylcellulose, starch, water-soluble vinyl polymers (Carbopol® brand sold by B.F. Goodrich), polyhydroxyethle methacrylate, and combinations thereof Core material suitable for use in the present invention include polystyrene, high impact polystyrene, polypropylene, filled polypropylene, nylon, and blends such as 70% nylon/30% polyethylene oxide, 60% polystyrene/40% polyethylene oxide.

Optionally, the core material can include additives such as lubricants foaming agents, microspheres, baby powders, fillers such as CaCo₃, colorants such as TiO₂ silicone copolymers, sucrose stearate, vitamin E, panthenol, aloe, essential oils, e.g. menthol, and combinations thereof.

In an embodiment of the present invention a wear indicating effect is produced when the sheath material and the core material are made of disparately colored materials (e.g. white colored sheath and blue colored core). Upon use, the sheath material over the skin engaging surface is typically worn off through use. With sufficient use, a second colored region represented by the core is exposed, thus, providing the user with and indication that the shaving unit and/or skin engaging surface have reached their effective life. In a preferred embodiment, the sheath material consists of polyethylene oxide /polystyrene mixture which is white in color and the core consists of nylon and/or styrene which has been colored with a FD&C #2 dye. Other suitable dyes or pigments include FD&C Red No. 40, Erythrosine (FD&C Red No. 3), Brilliant Blue FCF (FD&C Blue No. 1), Indigotine (FD&C Blue No. 2), Tartozine (FD&C Yellow No. 5), Sunset Yellow FCF (FD&C Yellow No. 6) and Fast Green FCF (FD&C Green No. 3) and Titanium Dioxide.

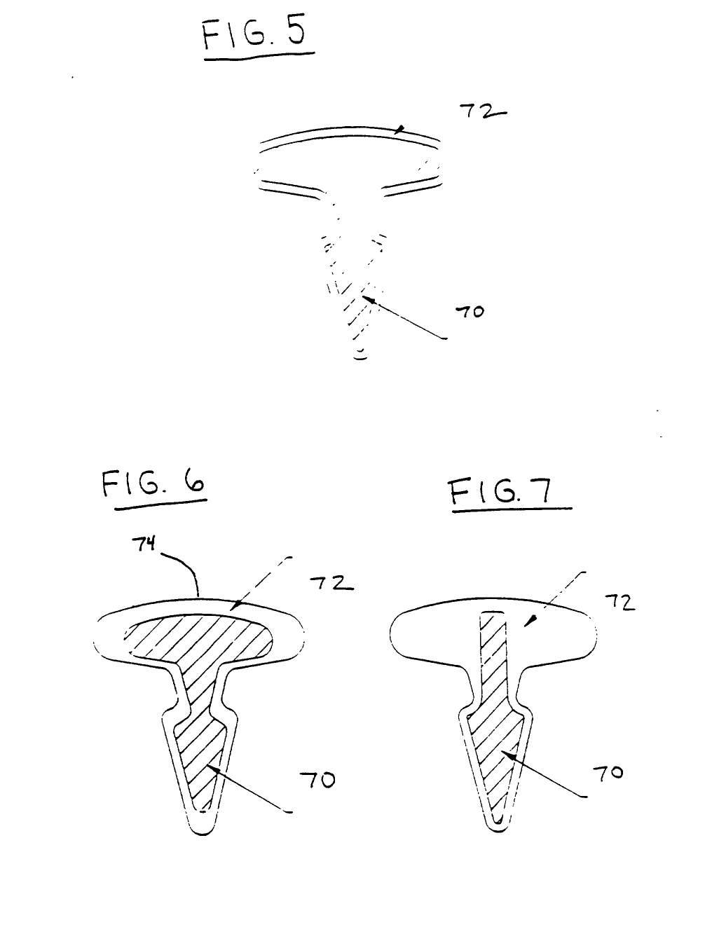

FIG. 5 depicts a cross section of an alternate skin engaging member. The core material 70, follows the general contours of the surface defined by the outside of the sheath material. FIG. 6 depicts a slight variation on that theme where a thicker sheath layer is provided along the skin engaging surface 74 still further, FIG. 7 provides a cross-section wherein a very high degree of sheath material is present along the skin engaging surface.

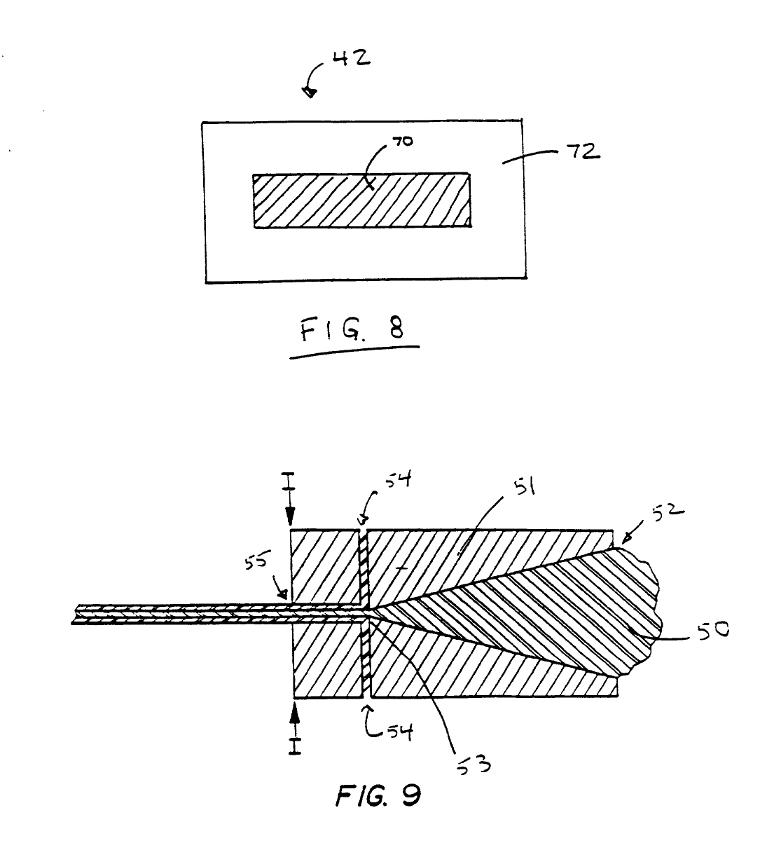

FIG. 8 shows an alternate embodiment wherein the skin engaging member has a triangular cross section. Finally, FIG. 9 depicts the skin engaging member depicted in FIGS. 1 and 2. It is interesting to note that the core in this case provides mechanical strength to the unit yet is not vital to the mechanical locking of the unit. The skin engaging member of FIGS. 1 and 2 are affixed by adhesive. According to the present invention, the skin engaging members may be a affixed by adhesive such as Loctite Super Bonder 499, mechanical locking mechanism, thermal welds.

FIG. 10 is a schematic cross section diagram of an extrusion die suitable for manufacturing the skin engaging member of the present invention. Core material is fed into the intrusion die 51 by an extrusion screw, hot melt or other suitable means. In the core inlet port 52 the tight core orifice 53 encounters the sheath material wherein the core becomes encapsulated by the sheath material when viewed in a transverse cross section to the flow of the die material. The encapsulated core than proceeds to the die outlet 55 wherein the continuous skin engaging members can be cured and/or drawn down to provide the appropriate dimensions. Also, it should be noted that the core material could consist of a solid wire or solid plastic material which is fed in through a conventional die to produce an encapsulated skin engaging member. For general discussion of coextrusion technology see Levi, Plastics Extrusion Technology Handbook. Industrial Press Inc., pages 168-188 (1981), incorporated herein by reference. After the continuous skin engaging members are produced, the strand is sent for further processing where it is typically drawn down to the correct size and cut to length suitable for implant into the body of a razor blade cartridge. This cutting can be achieved by knife edge cutting, lasers or water lasers. The skin engaging surfaces of the present invention typically are rectangular in shape with a width of from about 0.05 inches to about 0.1 inches and a length of about 1.2 inches.

Applicant considers equivalent embodiments to be part of the present invention. For example, non-rectangular skin engaging surface areas may be utilized (such as ovals) and non-flat surface patterns could be utilized. These and other equivalent embodiments are also contemplated by the present invention. The present invention and the manner of making and using the same should be evident from the following examples:

### EXAMPLES

The following samples were coextruded with a cross-section as in FIG. 5.

| No. | Core Material | Sheath Material |
|---|---|---|
| 1 | Nylon 70% | polystyrene 10% |
| | blue pigment 0.5% | polyethylene oxide 76% |
| | polyethylene oxide 29 5% | polyvinyl acetate 8% |
| | | polyethylene glycol 5% |
| | | white pigment 1% |
| 2 | 25% polyethylene oxide | 78% polyethylene oxide |
| | 25% nylon | 14% polystyrene |
| | | 3% polyethylene glycol |
| | | 5% polyvinyl acetate |
| 3 | 100% polystyrene | 82% polyethylene oxide |
| | | 14% polystyrene |
| | | 3% polyethylene glycol |
| | | 1% polyvinyl acetate |
| 4 | 70% nylon | 80% polyethylene oxide |
| | 29.5% polyethylene oxide | 16% polystyrene |
| | 0.5% blue dye | 4% polyvinyl acetate |
| 5 | 98% polystyrene | 73% polyethylene oxide |
| | 2% blue dye | 5% Salsorb |
| | | 5% polyvinyl acetate |
| 6 | 100% polystyrene | 74% polyethylene oxide |
| | | 10% polystyrene |
| | | 10% polyvinyl acetate |
| | | 5% polyethylene glycol |
| | | 1% white TiO2 pigment |
| 7 | 98% polystyrene | 68% polyethylene oxide |
| | 2% blue dye | 15% polyvinyl acetate |
| | | 10% polystyrene |
| | | 5% polyethylene glycol |
| | | 2% white TiO2 pigment |
| 8 | 100% polystyrene | 67% polyethylene oxide |
| | | 4% Salsorb |
| | | 14% polyvinyl acetate |
| | | 10% polystyrene |
| | | 4% polyethylene glycol |
| | | 1% white TiO2 pigment |
| 9 | 99% polystyrene | 68% polyethylene oxide |
| | 1% blue dye | 20% polyvinyl acetate |
| | | 10% polystyrene |
| | | 2% white TiO2 pigment |
| 10 | 99% polystyrene | 70% polyethylene oxide |
| | 1% blue dye | 13% polyvinyl acetate |
| | | 15% polystyrene |
| | | 2% white TiO2 pigment |
| 11 | 99% polystyrene | 65% polyethylene oxide |
| | 1% blue dye | 15% polyvinyl acetate |
| | | 15% polystyrene |
| | | 3% Salsorb |
| | | 2% white TiO2 pigment |
| 12 | 99% polystyrene | 65% polyethylene oxide |
| | 1% blue dye | 10% polyvinyl acetate |
| | | 15% polystyrene |
| | | 3% Salsorb |
| | | 2% white TiO2 pigment |

### Example 12

The following procedure can be used to produce a skin engaging member of the type depicted in FIG. 4.

The extrusion equipment includes two single-screw extruders, a die cross-head, a cooling channel, and a puller. The strip extruded from the extruders is pulled through a cooling tunnel by a Farris puller (a take-off machine) at a speed of approximately 10 feet per minute with minimum tension on the strip. The strip is air-cooled by blowing dry compressed air into the tunnel at approximately 10 CFM. The extrudate is kept in a cool, dry room.

The core blend (70% Zytel 330 brand amorphous nylon/blue pigment, 30% ethlyene oxide/styrene blend 60/40 is extruded through the first ¾″ Haake extruder (barrel pressure of 4,343 psi and temperature of 180 C). The sheath blend (80% polyethylene oxide/styrene 60/40, 14% polystryene/white color, 3% PEG, and 3% PVA 2025) is extruded through the second ¾″ Haake extruder (barrel pressure of 6,131 psi and temperature of 180° C.). The two materials are then joined and be fed through a cross-head at a temperature of 180° C., die temperature of 180° C., and die pressure of 3,600 psi to form a continues lubricating strip. The line speed is approximately 10 FPM.

What is claimed is:

1. A skin engaging member for use in a shaving system of the wet shave type comprising:
an elongated sheath region comprised of a mixture of a water-soluble shaving aid and a non-water soluble material; and
a rigid core region extending axially throughout said sheath.

2. The skin engaging member of claim 1 wherein said water soluble shaving aid is selected from the group consisting of polyethylene oxide, polyvinyl pyrrolideone, polyacrylamide, hydroxypropyl cellulose, polyvinyl imidazonline, polyvinyl pyrrolidone, poly-acrylamide, hydroxyproplyl cellulose, polyethylene glycol, polyvinyl alcohol, methyl cellulose, starch, water-soluble vinyl polymers, polyhydroxyethylmethacrylate, silicone copolymers, sucrose stearate, vitamin E, panthenol, aloe, essential oils and combinations.

3. A skin engaging member according to claim 2 wherein said water insoluble materials are selected from the group consisting of nylon, ethylene-vinyl acetate copolymer, polyethylene, polypropylene, polystyrene, polyacetyl and combinations thereof.

4. A skin engaging member according to claim 3 wherein said sheath comprises from about 70% to about 100% by weight of said water insoluble material and from 0% to about 30% by weight of said water soluble material.

5. A skin engaging member according to claim 4 further comprising additional sheath components selected from the group consisting of plastisizers, beard softeners, lubricants, shaving aids, fillers, tackifiers, fragrances, antipruritic/counterirritant materials, antimicrobial/keratolytic materials, anti-inflammatory agents, astringents, surfactants, comptibilizers, blowing agents or combinations thereof.

6. A skin engaging member according to claim 5 wherein said release agent is selected from the group consisting of polyethylene glycol, methoxyppolyethylene glycol, methylcellulose, carboxypolymethylene and combinations.

7. A skin engaging member according to claim 6 further comprising an elongated skin engaging surface extending at least along a portion of the outer surface of said sheath region.

8. A skin engaging member according to claim 7 wherein said sheath region and said core region are applied via coextrusion.

9. A skin engaging member according to claim 8 wherein said core member and said sheath member are fabricated from materials which exhibit different core and sheath colors wherein upon use, said sheath member will wear along said skin engaging surface to expose said different colored core region thus providing an indication that the skin engaging member has reached its desired life.

10. A shaving system of the wet shave type comprising a blade member, and structure defining an external skin engaging member adjacent the shaving edge of said blade member, said skin engaging member comprised of: an elongated sheath region comprised of a mixture of a water-soluble shaving aid and a non-water soluble material; and, a rigid core region extending axially throughout said sheath.

11. The shaving system of claim 10 wherein said water soluble shaving aid is selected from the group consisting of polyethylene oxide, polyvinyl pyrrolideone, polyacrylamide, hydroxypropyl cellulose, polyvinyl imidazonline, polyvinyl pyrrolidone, poly acrylamide, hydroxypropyl cellulose, polyethylene glycol, polyvinyl alcohol, methyl cellulose, starch, water-soluble vinyl polymers, polyhydroxyethylmethacrylate, silicone copolymers, sucrose stearate, vitamin E, panthenol, aloe, essential oils and combinations.

12. A shaving system according to claim 11 wherein said water insoluble materials are selected from the group consisting of nylon, ethylene-vinyl acetate copolymer, polyethylene, polypropylene, polystyrene, polyacetyl and combinations thereof.

13. A shaving system according to claim 12 wherein said sheath comprises from about 70% to about 100% by weight of said water insoluble material and from 0% to about 30% by weight of said water soluble material.

14. A shaving system according to claim 13 further comprising additional sheath components selected from the group consisting of plastisizers, beard softeners, lubricants, shaving aids, fillers, tackifiers, fragrances, antipruritic/counterirritant materials, antimicrobial/keratolytic materials, anti-inflammatory agents, astringents, surfactants, comptibilizers, blowing agents or combinations thereof.

15. A shaving system according to claim 14 wherein said release agent is selected from the group consisting of polyethylene glycol, methoxyppolyethylene glycol, methylcellulose, carboxypolymethylene and combinations.

16. A shaving system according to claim 15 further comprising an elongated skin engaging surface extending at least along a portion of the outer surface of said sheath region.

17. A shaving system according to claim 16 wherein said sheath region and said core region are applied via coextrusion.

18. A shaving system according to claim 17 wherein said core member and said sheath member are fabricated from materials which exhibit different core and sheath colors wherein upon use, said sheath member will wear along said skin engaging surface to expose said different colored core region thus providing an indication that the skin engaging member has reached its desired life and/or that the razor has reached its desired life.

19. A process for forming a skin engaging member for use in a shaving system of the wet shave type that comprising the steps of:
providing a sheath blend of said water insoluble polymeric material and said water leachable shaving aid material;
providing a core polymeric blend; and
coextruding the core and sheath such that the core material is extending axially throughout said sheath.
